(19) United States
(12) Patent Application Publication
(10) Pub. No.: US 2025/0328814 A1
(43) Pub. Date: Oct. 23, 2025

(54) GENERATING CONVERSATION CONTENT FOR TRAINING CONVERSATIONAL ARTIFICIAL INTELLIGENCE

(71) Applicant: INTERNATIONAL BUSINESS MACHINES CORPORATION, ARMONK, NY (US)

(72) Inventors: Sungeun An, Lilburn, GA (US); Robert John Moore, San Jose, CA (US); JAY PANKAJ GALA, San Jose, CA (US); Marina Danilevsky Hailpern, San Jose, CA (US); Divyesh Jadav, San Jose, CA (US)

(21) Appl. No.: 18/640,496

(22) Filed: Apr. 19, 2024

(51) Int. Cl. G06N 20/00

(52) U.S. Cl. CPC G06N 20/00

(57) ABSTRACT

According to one embodiment, a method, computer system, and computer program product for generating natural conversation content for training conversational artificial intelligence (AI) systems is provided. The present invention may include receiving conversation content comprising one or more conversation sequences; assigning one or more labels to one or more utterances comprising the conversation sequences using a machine learning-based intent classifier to produce a plurality of labeled conversation content; determining if a confidence score for at least one of the assigned labels is below a predetermined threshold; determining at least one variant operation of a plurality of variant operations to perform on the labeled conversation content using a natural conversation variator; and performing the at least one operation of the plurality of variant operations on the labeled conversation content using the natural conversation variator to generate one or more variations of the labeled conversation content.

### BACKGROUND

The present invention relates, generally, to the field of computing, and more particularly to conversational artificial intelligence (AI) systems, and specifically, the training of conversational AI systems.

Conversational artificial intelligence is a type of AI that enables computers to understand, process, and generate human language in the form of natural conversation interaction. Conversational AI combines natural language processing (NLP) with machine learning to process, understand, and generate responses while communicating with users. Conversational AI systems are trained on large volumes of data, such as speech and text inputs. Machine learning and natural language processing are used to teach the system to imitate natural conversation, or human interaction, recognize the speech and text inputs, as well as translate the inputs' meanings across various languages.

### SUMMARY

Embodiments of a method, a computer system, and a computer program product for generating natural conversation content for training conversational artificial intelligence (AI) systems are described. According to at least one embodiment, a method, computer system, and computer program product for generating natural conversation content for training conversational artificial intelligence systems may include receiving conversation content comprising one or more conversation sequences; assigning one or more labels to one or more utterances comprising the one or more conversation sequences using a machine learning-based intent classifier to produce a plurality of labeled conversation content; determining if a confidence score for at least one of the one or more assigned labels is below a predetermined threshold; determining at least one variant operation of a plurality of variant operations to perform on the plurality of labeled conversation content using a natural conversation variator; and performing the at least one operation of the plurality of variant operations on the plurality of labeled conversation content using the natural conversation variator to generate one or more variations of the plurality of labeled conversation content.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating a content generation for conversational AI training process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate generally to the field of computing, and in particular to conversational artificial intelligence systems, namely, the training of conversational AI systems. The following described exemplary embodiments provide a method, program product, and system to, among other things, generate natural conversation content for training conversational artificial intelligence (AI) systems using a conversational action classifier and a natural conversation variator. Therefore, the present embodiment has the capacity to improve the training of conversational AI systems by generating a greater quantity of training data while maintaining the training data's natural structure.

Currently, training a conversational AI requires large volumes of high-quality training examples to teach the system how to understand and process human language. This is especially true regarding content-grounded conversational AIs because the training examples must be grounded in document-specific knowledge and thus, are limited. Content-grounded conversation AIs connect the model's output to verifiable sources of information. By providing the model with access to specific data sources, grounding tethers the model's output to specific data and reduces the chances of inventing content. Current methods often involve generating training examples by changing the language within conversation content, such as a transcript. However, it remains challenging to create high-quality examples and expensive to generate the number of training examples needed to train a conversational AI system. Under many current methods in the art, training examples may be generated by using NLP models to change, add, or remove utterances. An utterance can be a statement by one person. Additionally, training examples may be generated by varying the turns of a conversation in a transcript using shifting and stemming methods to remove and/or combine the turns. The drawback of generating training examples using the current methods is that new conversational structures may not be created. Additionally, removing and combining sections of a conversation may compromise the naturalness of the conversation by occasionally generating invalid variants. Thus, an implementation of generating natural conversation content for training conversational AI systems is needed, in which multiple alternatives, but natural, conversation variation paths (comprising variations of the conversation structure but not variations of the language of the conversation content) are generated from conversation content.

Thus, embodiments of the present invention may provide advantages including, but not limited to, generating a greater quantity of training data and increasing the quality of training data for conversational AI systems compared with common methods in the art, while reducing the cost of generating the training data. Embodiments of the present invention can generate multiple alternative and diverse conversation paths of a conversation within a transcript and preserve the knowledge of what is in the content of the transcript and the naturalness of the conversation by rearranging, adding, and/or removing interactional structures of the conversation. As a result, the present invention can strengthen a conversational AI system's robustness to rich and diverse natural languages, adaptability to a wide range of scenarios, and ability to generalize to new and unseen data. The present invention does not require that all advantages need to be incorporated into every embodiment of the invention.

In at least one embodiment of the invention, a conversation sequence in an existing transcript from a customer service chatbot interaction may comprise:

C: I am 70 years old and will retire at the end of this year.

C: Am I eligible to retire under the Company Personal Pension Plan?

A: Congratulations on your upcoming retirement!

A: May I ask how many years you have worked at the Company for?

C: 30 years.

A: That sounds great!

A: Yes, you are eligible for the Company Personal Pension Plan.

The conversation sequence in the above existing transcript comprises utterances from a customer, referred to as “C”, as well as utterances from an agent, referred to as “A”.

Using the conversation action classifier, the program may label the utterance “I am 70 years old and will retire at the end of this year.” as a detail. The program may label the utterance “Am I eligible to retire under the Company Personal Pension Plan?” as an inquiry. The program may label the utterance “Congratulations on your upcoming retirement!” as a positive assessment. The program may label the utterance “May I ask how many years you have worked at the Company for?” as a detail request. The program may label the utterance “30 years” as a detail. The program may label the utterance “That sounds great!” as a positive assessment. The program may label the utterance “Yes, you are eligible for the Company Personal Pension Plan.” as an answer.

Using the natural conversation variator, the program may determine that the transcript comprises a certain language pattern based on the inquiry, detail request, detail, and answer labeled utterances. The natural conversation variator can determine that the full request variant operation can be performed on the labeled transcript because of the presence of the detected language pattern. Using the natural conversation variator, the program can perform the full request variant operation on the conversation sequence to generate a new conversation variation, as follows:

C: I am 70 years old and will retire at the end of this year. [Detail]

C: Am I eligible to retire under the Company Personal Pension Plan? [Inquiry]

C: I have been working at Company for 30 years. [New Detail]

A: Yes, you are eligible for the Company Personal Pension Plan. [Answer]

In the generated conversation variation, the natural conversation variator removes the positive assessment-labeled utterances and creates a new detail-labeled utterance (“I have been working at Company for 30 years”) by combining the detail request-labeled utterance (“May I ask how many years you have worked at the Company for?”) with the detail-labeled utterance (“30 years”).

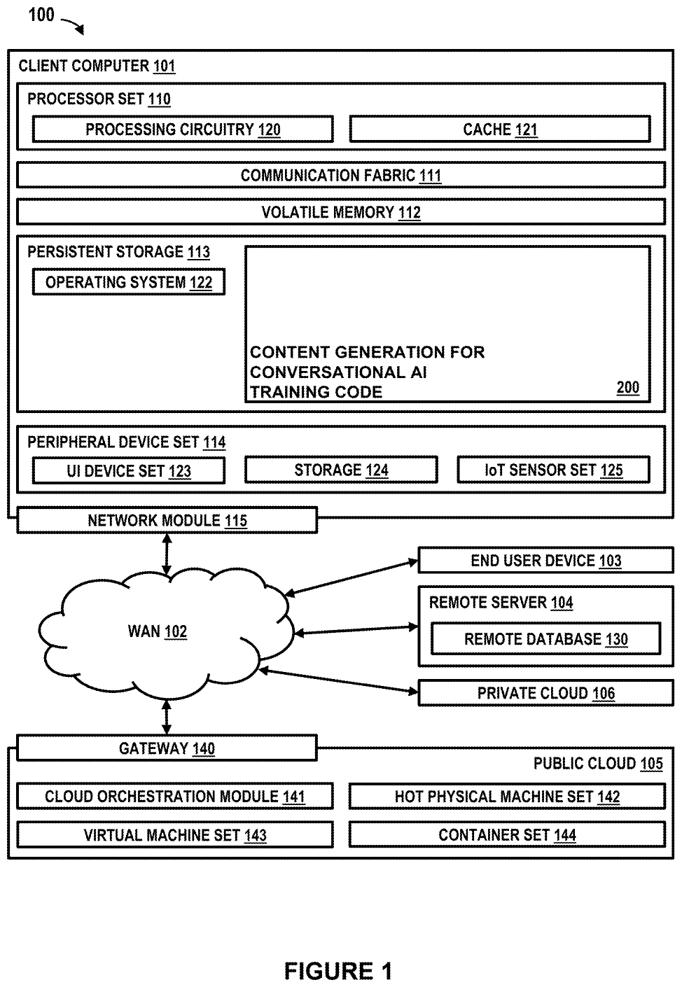

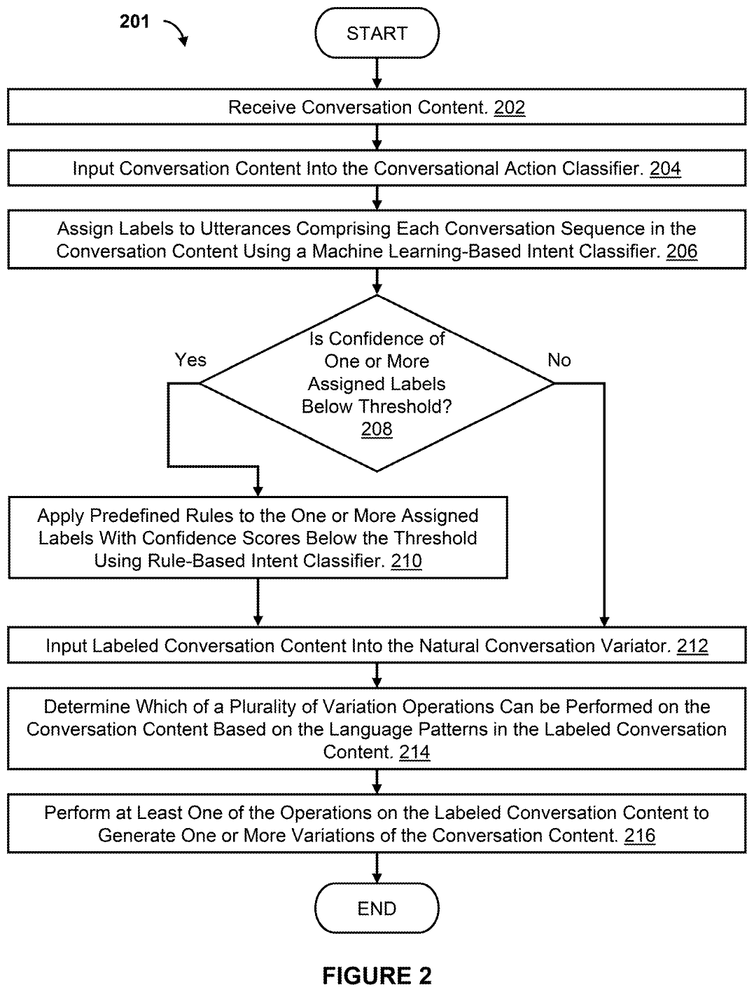

The embodiments mentioned in this paragraph are further illustrated and described below in the discussions of FIGS. 1 and 2. According to at least one embodiment, the program receives conversation content comprising one or more conversation sequences. The program assigns one or more labels to one or more utterances comprising the one or more conversation sequences using a machine learning-based classifier to produce a plurality of labeled conversation content. Also, the program determines if a confidence score for at least one of the one or more assigned labels is below a predetermined threshold. Furthermore, the program determines at least one variant operation of a plurality of variant operations to perform on the plurality of labeled conversation content using a natural conversation variator. Moreover, the program performs the at least one operation of the plurality of variant operations on the plurality of labeled conversation content using the natural conversation variator to generate one or more variations of the plurality of labeled conversation content.

According to at least one other embodiment, responsive to determining that a confidence score for at least one of the one or more assigned labels is below the predetermined threshold value, the program applies one or more predefined rules to the one or more assigned labels with low confidence scores using a rule-based classifier. According to at least one other embodiment, the assigning of the label to the one or more utterances comprising the one or more conversation sequences using the machine learning-based intent classifier is based on an utterance's respective generic conversational function. According to at least one other embodiment, the determining of the at least one variant operation of the plurality of variant operations to perform on the plurality of labeled conversation content is based on one or more conversation patterns in the plurality of labeled conversation content. According to at least one other embodiment, the conversational action classifier, and the natural conversation variator are grounded in a natural conversation framework. According to at least one other embodiment, the natural conversation variator incorporates a rule-based system including the plurality of variant operations. According to at least one other embodiment, the program assigns the one or more labels to the one or more utterances using a trained machine learning model.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to receive conversation content comprising one or more conversation sequences, assign one or more labels to one or more utterances comprising the one or more conversation sequences using a machine learning-based intent classifier to produce a plurality of labeled conversation content, determine if a confidence score for at least one of the one or more assigned labels is below a predetermined threshold, determine at least one variant operation of a plurality of variant operations to perform on the plurality of labeled conversation content using a natural conversation variator, and perform the at least one operation of the plurality of variant operations on the plurality of labeled conversation content using the natural conversation variator to generate one or more variations of the plurality of labeled conversation content.

Referring to FIG. 1, an exemplary networked computer environment 100 is depicted, according to at least one embodiment. Computing environment 100 contains an example of an environment for the execution of at least some of the computer code involved in performing the inventive methods, such as content generation for conversational AI training code 200, also referred to as “content generation for conversational AI training program 200”, or “the program 200”. In addition to code block 200 computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, scanner, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The database 130 may be a digital repository capable of data storage and data retrieval. The database 130 can be present in the remote server 104 and/or any other location in the network 102. The database 130 can store the conversational action classifier and the natural conversation variator. Additionally, the database 130 can the data used to train the conversational action classifier and the natural conversation variator, as well as the outputs of the classifier and the variator. Also, the database 130 can comprise uploaded conversation content, such as transcripts, etc., as well as the generated variations of the uploaded conversation content. The database 130 can comprise the IBM™ Natural Conversation Framework (IBM™ and all IBM™-based trademarks and logos are trademarks or registered trademarks of IBM Corporation, and/or its affiliates).

According to the present embodiment, the content generation for conversational AI systems training program 200 may be a program capable of receiving conversation content. The program 200 may be capable of assigning labels to each utterance in the conversation content using a machine learning-based intent classifier and determining if a confidence score for at least one of the one or more assigned labels is below a predetermined threshold. The program 200 may be capable of determining at least one variant operation of a plurality of variant operations to perform on the labeled conversation content using a natural conversation variator. Also, the program 200 may be capable of performing the at least one variant operation of the plurality of variant operations on the inputted labeled conversation content using the natural conversation variator to generate one or more variations of the labeled conversation content. Additionally, responsive to determining that a confidence score for at least one of the one or more assigned labels is below the predetermined threshold value, the program 200 may be capable of applying one or more predefined rules to the one or more assigned labels with confidence scores below the predetermined threshold. The program 200 may be located on client computing device 101 or remote server 104 or on any other device located within network 102. Furthermore, the program 200 may be distributed in its operation over multiple devices, such as client computing device 101 and remote server 104. The content generation for conversational AI training method is explained in further detail below with respect to FIG. 2.

Referring now to FIG. 2, an operational flowchart illustrating a content generation for conversational AI training process 201 is depicted according to at least one embodiment. At 202, the program 200 receives existing conversation content. Existing conversation content can be a written record of a conversation between two people, such as an agent and a customer. Conversation content can comprise existing archives, documents, forms, pages, records, and reports, such as transcripts, chatbot interactions, virtual agent interactions, etc. The conversation content can include one or more conversation sequences. A conversation sequence may be two or more adjacent and functionally related turns (i.e., one speaker states a conversational action, and a second speaker responds to it with a relevant next action, such as a greeting-greeting, offer-acceptance, inquiry-answer, etc.). A conversation sequence can include one or more utterances (i.e., a statement by one person). The program 200 may receive conversation content by retrieving it from the database 130 or through WAN 102, such as from UI device set 123.

At 204, the program 200 inputs the conversation content into a conversational action classifier (CAC). The CAC can be a multiclass classifier that incorporates a machine learning-based intent classifier and a rule-based intent classifier. The machine learning-based intent classifier can be a natural language classification model. The program 200 can train the machine learning-based classifier by using phrase-training data to group examples of the same action in the same class. Example phrase-training data includes utterances with attached labels, such as “Good morning”, labeled as a “greeting”, “A regular, full-time employee will receive 12 paid holidays each year”, labeled as an “Answer”, “How long has this employee worked for you?”, labeled as a “Detail Request”, “How are you doing?”, labeled as a “Welfare Check”, “Can you help me with a problem?”, labeled as a “Help Request”, “Am I eligible for EAP”, labeled as an “Inquiry”, “Alright”, labeled as an “Acknowledgment”, “Why are you asking?”, labeled as a “Warrant Request”, “I have got to go”, labeled as a “PreClosing”, “How can I help you today?”, labeled as an “Offer Of Help”, “Any more questions I can assist you with?”, labeled as an “Anything Else”, “I am sorry that I do not have that information on my end”, labeled as a “No Answer”, etc. The rule-based intent classifier can be an intent classification model that uses a rule-based system to classify the utterances in conversation content.

In embodiments, the program 200 can ground the CAC in the IBM™ Natural Conversation Framework (NCF) (IBM™ and all IBM™-based trademarks and logos are trademarks or registered trademarks of IBM Corporation, and/or its affiliates). Specifically, the program 200 can connect the CAC to the pattern language in the NCF to ensure the CAC's conformity with the NCF. The NCF can comprise four parts: (1) an underlying interaction model of expandable sequences; (2) a distinctive corresponding content format based on the interaction model; (3) a language pattern of reusable patterns for common conversational activities; and (4) a general method for navigating conversational applications. The program 200 may ground the CAC using a data and knowledge base integration method, such as retrieval-augmented generation (RAG) in which data is retrieved from the database 130 to ground the CAC on the most accurate and up-to-date information.

At 206, the program 200 assigns labels to the utterances comprising each conversation sequence in the inputted conversation content using a machine learning-based intent classifier. The CAC can process the conversation content through the machine learning-based intent classifier to output labeled utterances. The machine learning-based intent classifier can label utterances based on the conversational function the utterance performs. Conversational functions can be defined as the ordinary conversational actions, such as greet, offer, request, repeat, paraphrase, acknowledge, farewell, etc. In addition to assigning a label to each utterance, the machine learning-based intent classifier may assign a confidence score to each of the labeled utterances based on how confident the classifier is that the label assigned to the respective utterance is correct. Confidence score values may comprise zero (0.0) through one (1.0).

In at least one embodiment of the invention, the program 200 may assign the one or more labels to the one or more utterances using a trained machine learning model, such as a large language model. The program 200 may train the machine learning model using the phrase-training data.

The CAC may comprise fifty-two (52) use-case-specific NCF labels. For example, labels available to label an agent's utterances may include ‘acknowledgment’, ‘affirmation’, ‘answer’, ‘anythingElse’, ‘apology’, ‘appreciation’, ‘appreciationReceipt’, ‘assessmentNegative’, ‘assessmentPositive’, ‘checking’, ‘closing’, ‘confirmRequest’, ‘criteria’, ‘detailRequest’, ‘disaffirmation’, ‘elaborate’, ‘elaborate’, ‘expandTopic’, ‘feedback’, ‘greeting’, ‘n/a’, ‘nameGiving’, ‘nameRequest’, ‘noAnswer’, ‘offerHelp’, and ‘offerOfHelp’. Additionally, for example, labels available to label a customer's utterances may include ‘abortSequence’, ‘inquiry’ ‘acknowledgment’, ‘affirmation’, ‘anythingElse’, ‘apology’, ‘appreciation’, ‘appreciationReceipt’, ‘assessmentNegative’, ‘assessmentPositive’, ‘closing’, ‘confirmRequest’, ‘confirmation’, ‘detail’, ‘disaffirmation’, ‘duration’, ‘enrollment’, ‘exampleRequest’, ‘expandTopic’, ‘greeting’, ‘helpRequest’, and ‘hurry’.

At 208, the program 200 determines if a confidence score for at least one of the one or more assigned labels is below a predetermined threshold. According to one implementation, if the program 200 determines that the confidence score for at least one of the one or more assigned labels is below the predetermined threshold (step 208, “YES” branch), the program 200 may continue to step 210 to apply one or more predefined rules to the one or more assigned labels with confidence scores below the predetermined threshold. The program 200 may determine that the confidence score of one or more assigned labels is below a predetermined threshold if the confidence score is less than a preset threshold value, such as 0.4. If the program 200 determines that none of the confidence scores for the one or more assigned labels are below the predetermined threshold (step 208, “NO” branch), the program 200 may continue to step 212 to input the labeled conversation content into a natural conversation variator.

At 210, responsive to determining that a confidence score for at least one of the one or more assigned labels is below the predetermined threshold value, the program 200 applies one or more predefined rules to the one or more assigned labels with confidence scores below the predetermined threshold. The program 200 can apply one or more predefined rules to the assigned labels with confidence scores below the predetermined threshold using the rule-based intent classifier. The rule-based classifier can make a class decision by using one or more “IF-THEN” rules for classification. An “IF-THEN” rule can be an expression of the form IF condition (antecedent) and THEN conclusion (consequent). The rule-based intent classifier can output an assigned label for an utterance. The assigned label from the rule-based intent classifier can replace the low-confidence assigned label from the machine learning-based intent classifier.

An exemplary “IF-THEN” rule may state that if the given utterance follows a question sentence structure, for example, the sentence begins with words such as “what”, “when”, “how”, etc., and ends with a question mark, then the rule sets the “Is Question” flag to “True” for the utterance. Another exemplary “IF-THEN” rule may state that if the given utterance follows a request sentence structure, for example, the sentence begins with phrases such as “I want to know”, “I need to know”, etc., then the rule sets the “Is Request” flag as “True” for the utterance. Also, an exemplary “IF-THEN” rule may state that if the given utterance has predefined domain keyboards, for example, program, account, full-time, insurance, etc., then the rule sets the “Has Domain Keyword(s)” flag as “True” for the utterance. Another exemplary “IF-THEN” rule may state that if the given utterance follows a confirm request sentence structure, for example, the sentence includes phrases such as “so . . . right?”, “so . . . correct?”, etc., then the rule sets the “Is Confirm Request” flag as “True” for the utterance. An exemplary “IF-THEN” rule may state that if the “Is Question” or “Is Request” flags of the utterance are “True” and the speaker of the utterance is a customer, then the rule assigns the “Inquiry” label to the utterance. Another exemplary “IF-THEN” rule may state that if the “Confirm Request” flag of the utterance is “True” and the speaker of the utterance is a customer, the rule assigns the “Confirm Request” label to the utterance. Also, an exemplary “IF-THEN” rule may state if the “Is Question” and “Has Domain Keyword(s)” flags of the utterance are “True” and the speaker of the utterance is an agent, then the rule assigns the “Detail Request” label to the utterance. An exemplary “IF-THEN” rule may state if the “Is Question” flag of the utterance is not “True” and the “Has Domain Keyword(s)” flag of the utterance is “True”, and the speaker of the utterance is a customer, the rule assigns the “Detail Giving” label to the utterance. Another exemplary “IF-THEN” rule may state if the “Is Question” flag of the utterance is not “True” and the “Has Domain Keyword(s)” flag of the utterance is “True”, and the speaker of the utterance is an agent, then the rule assigns the “Answer” label to the utterance.

At 212, the program 200 inputs the labeled conversation content into a natural conversation variator (NCV). The NCV can be a variator component that incorporates a rule-based system. The program 200 can ground the NCV in the IBM™ Natural Conversation Framework (IBM™ and all IBM™-based trademarks and logos are trademarks or registered trademarks of IBM Corporation, and/or its affiliates). Specifically, the program 200 can connect the NCV to the pattern language in the NCF to ensure the NCV's conformity with the NCF. The program 200 can train the large language model using few-shot prompting. The program 200 may ground the NCV using a data and knowledge base integration method, such as retrieval-augmented generation (RAG) in which data is retrieved from the database 130 to ground the NCV on the most accurate and up-to-date information. The rule-based system can include a plurality of pre-defined variant operations programmed into the model. The plurality of pre-defined variant operations can be used to generate variations of conversation content, such as removing utterances in a conversation sequence, combining utterances in a conversation sequence, reordering utterances in a conversation sequence, generating novel utterances in a conversation sequence, or generating novel conversation sequences.

Specifically, each of the plurality of pre-defined variant operations includes distinct rule-based operators and/or machine learning models, such as a large language model, that can be applied to conversation sequences to generate one or more distinct variations of the labeled transcript. For example, a full request variant operation may be performed on a conversation sequence in which an agent requests detail from the user and the user provides it. Also, for example, a partial request variant operation may be performed on a conversation sequence in which a user provides details before or during an inquiry from the agent. For example, an insert preliminary variant operation may be performed on a conversation sequence in which the user directly addresses an inquiry without any preliminary request from the agent. Also, for example, an agent extended telling variant operation may be performed on a conversation sequence in which an agent gives an answer that is more than three sentences in one conversation sequence. For example, an insert warrant request variant operation may be performed on a conversation sequence in which an agent gives reasons before requesting a detail from the user. Also, for example, an expand topic variant operation may be performed on a conversation sequence in which an agent expands the topic of a conversation by asking a question to the user. For example, an elaborate request operation may be performed on a conversation sequence in which a user provides details before inquiring. Also, for example, a minimization variant operation may be performed on a conversation sequence in which non-important utterances exist, such as thank you, hello, okay.

At 214, the program 200 determines at least one variant operation of a plurality of the variant operations to perform on the labeled conversation content based on one or more language patterns in the labeled conversation content. The NCV can determine which of the plurality of variant operations can be performed on the labeled conversation content based on the presence of certain language patterns in the conversation content. Language patterns may comprise generic conversational language patterns and language sub-patterns as grounded in the NCF. For example, an open request language pattern may comprise a full request-labeled utterance, a grant-labeled utterance, a sequence closer-labeled utterance, and a receipt-labeled utterance. Also, for example, an open request screening language pattern may comprise a pre-request-labeled utterance, a go-ahead-labeled utterance, a full request-labeled utterance, a grant-labeled utterance, a sequence closer-labeled utterance, and a receipt-labeled utterance. Also, for example, an open request agent detail request language pattern may comprise a partial request-labeled utterance, a detail request-labeled utterance, a detail-labeled utterance, a grant-labeled utterance, a sequence closer-labeled utterance, and a receipt-labeled utterance. Also, for example, an inquiry pattern can comprise a conversation sequence in which a user's utterance is labeled an inquiry, an agent's utterance is labeled an answer, and the user's second utterance is labeled a sequence closer. Such a pattern may be illustrated in a transcript where a first user begins the conversation sequence by asking, “What computer won the Game Show?” A second user may answer, stating “An XYZ computer named Dotson.” The first user may conclude the conversation sequence, stating “Okay”. An additional illustration of an inquiry pattern may comprise a transcript where a first user begins the conversation sequence by asking, “Did you see the game last night?” A second user may answer, stating “Well, I only follow chess, so I did not.” The first user may conclude the conversation sequence, stating “Oh okay”.

At 216, the program 200 performs at least one operation of the plurality of variant operations on the inputted labeled conversation content to generate one or more variations of the labeled conversation content. The NCV can perform the one or more determined operations on the structure of the conversation sequences to generate variations of the labeled conversation content. The resulting generated variations can comprise structural variations of the original conversation content without the content or subjects of the interactions changed. Specifically, to generate variations comprising a change in the sequences or utterances of the conversation, the NCV applies the rules from the respective variant operations to the utterances and/or conversation sequences. Specifically, to generate novel utterances and/or conversation sequences, the NCV can input one or more utterances into the large language model to perform the one or more operations. The large language model can comprise several prompt generators including task descriptions. The NCV can output one or more novel variations of the inputted labeled conversation content using the prompt generator(s). The NCV may perform one or more operations on a certain conversation sequence in the conversation content, and one or more operations on another conversation sequence in the conversation content, etc. For example, the NCV may perform operations one and two on a conversation sequence in an inputted labeled transcript to generate a variant of the transcript. Additionally, the NCV may perform operations five and seven on another conversation sequence in the inputted labeled transcript to generate another variant of the transcript.

In an example, the performance of a full request variant operation may generate a variation in which the user provides details before an inquiry. In another example, the performance of a partial request variant operation may generate a variation in which the agent requests a detail from the user before being provided with the details. In an example, the performance of an insert preliminary variant operation may generate a variation in which the user asks for help before inquiring. In another example, the performance of an agent extended telling variant operation may generate a variation in which the agent gives an extended telling, allowing the user to acknowledge it before continuing with more information. In an example, the performance of an insert warrant request variant operation may generate a variation in which the user requests a warrant, and the agent explains the reasons behind the request. In another example, the performance of an expand topic variant operation may generate a variation in which the user expands the topic by asking a question to the agent. In an example, the performance of an elaborate request operation may generate a variation in which the agent asks the user to elaborate on their question. In another example, the performance of a minimization variant operation may generate a variation in which the unimportant utterances are removed from the conversation sequence.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating natural conversation content for training conversational artificial intelligence (AI) systems, the method comprising:
receiving conversation content comprising one or more conversation sequences;
assigning one or more labels to one or more utterances comprising the one or more conversation sequences using a machine learning-based intent classifier to produce a plurality of labeled conversation content;
determining if a confidence score for at least one of the one or more assigned labels is below a predetermined threshold;
determining at least one variant operation of a plurality of variant operations to perform on the plurality of labeled conversation content using a natural conversation variator; and
performing the at least one operation of the plurality of variant operations on the plurality of labeled conversation content using the natural conversation variator to generate one or more variations of the plurality of labeled conversation content.

2. The method of claim 1, further comprising:
responsive to determining that a confidence score for at least one of the one or more assigned labels is below the predetermined threshold value, applying one or more predefined rules to the one or more assigned labels with low confidence scores using a rule-based classifier.

3. The method of claim 1, wherein the assigning of the one or more labels to the one or more utterances comprising the one or more conversation sequences using the machine learning-based intent classifier is based on an utterance's respective generic conversational function.

4. The method of claim 1, wherein the determining of the at least one variant operation of the plurality of variant operations to perform on the plurality of labeled conversation content is based on one or more conversation patterns in the plurality of labeled conversation content.

5. The method of claim 1, wherein the conversational action classifier and the natural conversation variator are grounded in natural conversation framework.

6. The method of claim 1, wherein the natural conversation variator incorporates a rule-based system including the plurality of variant operations.

7. The method of claim 1, wherein the assigning of the one or more labels to the one or more utterances is performed using a trained machine learning model.

8. A computer system for generating natural conversation content for training conversational artificial intelligence (AI) systems, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving conversation content comprising one or more conversation sequences;
assigning one or more labels to one or more utterances comprising the one or more conversation sequences using a machine learning-based intent classifier to produce a plurality of labeled conversation content;
determining if a confidence score for at least one of the one or more assigned labels is below a predetermined threshold;
determining at least one variant operation of a plurality of variant operations to perform on the plurality of labeled conversation content using a natural conversation variator; and
performing the at least one operation of the plurality of variant operations on the plurality of labeled conversation content using the natural conversation variator to generate one or more variations of the plurality of labeled conversation content.

9. The computer system of claim 8, the method further comprising:
responsive to determining that a confidence score for at least one of the one or more assigned labels is below the predetermined threshold value, applying one or more predefined rules to the one or more assigned labels with low confidence scores using a rule-based classifier.

10. The computer system of claim 8, wherein the assigning of the one or more labels to the one or more utterances comprising the one or more conversation sequences using the machine learning-based intent classifier is based on an utterance's respective generic conversational function.

11. The computer system of claim 8, wherein the determining of the at least one variant operation of the plurality of variant operations to perform on the plurality of labeled conversation content is based on one or more conversation patterns in the plurality of labeled conversation content.

12. The computer system of claim 8, wherein the conversational action classifier and the natural conversation variator are grounded in natural conversation framework.

13. The computer system of claim 8, wherein the natural conversation variator incorporates a rule-based system including the plurality of variant operations.

14. The computer system of claim 8, wherein the assigning of the one or more labels to the one or more utterances is performed using a trained machine learning model.

15. A computer program product for generating natural conversation content for training conversational artificial intelligence (AI) systems, the computer program product comprising:
one or more computer-readable tangible storage medium and program instructions stored on at least one of the one or more tangible storage medium, the program instructions executable by a processor to cause the processor to perform a method comprising:
receiving conversation content comprising one or more conversation sequences;
assigning one or more labels to one or more utterances comprising the one or more conversation sequences using a machine learning-based intent classifier to produce a plurality of labeled conversation content;
determining if a confidence score for at least one of the one or more assigned labels is below a predetermined threshold;
determining at least one variant operation of a plurality of variant operations to perform on the plurality of labeled conversation content using a natural conversation variator; and
performing the at least one operation of the plurality of variant operations on the plurality of labeled conversation content using the natural conversation variator to generate one or more variations of the plurality of labeled conversation content.

16. The computer program product of claim 15, the method further comprising:
responsive to determining that a confidence score for at least one of the one or more assigned labels is below the predetermined threshold value, applying one or more predefined rules to the one or more assigned labels with low confidence scores using a rule-based classifier.

17. The computer program product of claim 15, wherein the assigning of the one or more labels to the one or more utterances comprising the one or more conversation sequences using the machine learning-based intent classifier is based on an utterance's respective generic conversational function.

18. The computer program product of claim 15, wherein the determining of the at least one variant operation of the plurality of variant operations to perform on the plurality of labeled conversation content is based on one or more conversation patterns in the plurality of labeled conversation content.

19. The computer program product of claim 15, wherein the machine learning-based intent classifier and a rule-based classifier are incorporated into a conversational action classifier.

20. The computer program product of claim 15, wherein the natural conversation variator incorporates a rule-based system including the plurality of variant operations.
